(19) United States
(12) Patent Application Publication
(10) Pub. No.: US 2023/0383911 A1
(43) Pub. Date: Nov. 30, 2023

(54) Cryogenic Fluid Dispensing System and Method

(71) Applicant: Chart Inc., Ball Ground, GA (US)

(72) Inventors: Corey J. Risty, Little Canada, MN (US); Thomas K. Drube, Lakeville, MN (US); Ian Neeser, Burnsville, MN (US); Joshua Steffen, Prior Lake, MN (US); Troy Lindquist, New Prague, MN (US)

(21) Appl. No.: 18/321,952

(22) Filed: May 23, 2023

Related U.S. Application Data
(60) Provisional application No. 63/345,193, filed on May 24, 2022.

(51) Int. Cl. F17C 7/04

(52) U.S. Cl. CPC F17C 7/04; F17C 2223/0161; F17C 2227/0142; F17C 2227/0306; F17C 2203/0391; F17C 2221/012; F17C 2265/065; F17C 2227/0185; F17C 2227/0178

(57) ABSTRACT

In a system for dispensing a cryogenic fluid, a bulk tank is configured to contain a supply of a cryogenic liquid. A sump is configured to receive cryogenic liquid from the bulk tank. A first positive-displacement pump is positioned within the sump and is configured to be submerged within and pump cryogenic liquid stored within the sump. A second positive-displacement pump is positioned within the sump and is configured to be submerged within and pump cryogenic liquid stored within the sump. A vaporizing heat exchanger is configured to receive and vaporize cryogenic liquid pumped from the first pump and/or the second pump.

### CLAIM OF PRIORITY

This application claims the benefit of U.S. Provisional Application No. 63/345,193, filed May 24, 2022, the contents of which are hereby incorporated by reference.

### FIELD OF THE DISCLOSURE

The present disclosure relates generally to systems and methods for dispensing cryogenic fluids, and more particularly, to a cryogenic fluid dispensing system and method that includes at least two pumps positioned within a sump where the sump selectively receives cryogenic liquid for pumping from a bulk storage tank.

### BACKGROUND OF THE INVENTION

Liquid hydrogen refueling stations are an emerging technology receiving increased interest due to advances in the development and usage of fuel cell electric vehicles, which are fueled by hydrogen. The SAE J2601 refueling protocol defines delivering gaseous hydrogen to a compressed hydrogen storage tank within the vehicle. Typically, such a compressed hydrogen storage tank within the vehicle supplies gaseous hydrogen to a fuel cell to power the vehicle.

Refueling stations that include liquid hydrogen storage offer advantages over compressor/tube trailer style stations, where the tubes contain hydrogen gas. More specifically, liquid hydrogen storage at a refueling station offers the opportunity to mix cold hydrogen gas with warm hydrogen gas to hit a targeted −38° C. dispenser temperature. In addition, the storage capacity of a liquid hydrogen storage station is vastly larger than is practical from a compressor/tube trailer style station. Tube trailers are typically 4000 psig, so they need a compressor on site to boost the pressure within buffer tanks to 12000 psig (830 barg). Furthermore, the small capacity of the tube trailers would typically require multiple swap outs (full for empty) per day of the tube trailers.

It is also possible to use a compressor in combination with liquid hydrogen storage, where the compressor pulls gaseous hydrogen off the top of the liquid hydrogen tank, warms the hydrogen, compresses it and directs the resulting gas to high pressure buffer tanks (such as tanks rated at ˜15000 psig). The compressor in such systems typically does not have the capacity to directly refuel a vehicle. To address this issue, a combination of compressor and buffer tank flow is sent to the vehicle being refueled to achieve the J2601 specified flowrate. The J2601 specified temperature may be achieved by directing the hydrogen gas stream (having the J2601 specified flowrate) through a heat exchanger that also receives a liquid hydrogen stream from the bulk storage tank so that the hydrogen gas stream is cooled. The warmed liquid hydrogen stream is returned to the bulk storage tank. This sends heat to the bulk storage tank, but enables cooling of the hydrogen gas stream to −40° F. The compressor pulling gas off of the tank headspace reduces bulk storage tank pressure so as to deal with heating in the system. Such a scheme, however, is limited by the high equipment costs of the required compressors. Alternatively, a commercial refrigeration system can be used to cool the hydrogen gas stream (having the J2601 specified flow rate) to the J2601 specified temperature, but this increases equipment costs as well.

A compressor has a cost that is much higher than the cost of a pump. This is especially true if the mass flowrate of the compressor is matched to that of the pump. As a result, positive displacement (piston) pumps from liquid hydrogen tanks represent an economical answer to hydrogen gas refueling of fuel cell electric vehicles. The pumped liquid hydrogen is vaporized to the target temperature via a vaporizer and mixing and control valves. Hydrogen gas buffer tanks can store vaporized liquid hydrogen for use in supplementing the flow from the pump during dispensing to level the load on the pump operation to some degree depending on the transient refrigeration needs to accomplish the delivery temperature. This permits use of a slightly smaller pump. Disadvantages of this approach include additional equipment costs of the hydrogen gas buffer tanks and additional pumping time to refill the buffer tanks.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a system for dispensing a cryogenic fluid includes a bulk tank configured to contain a supply of a cryogenic liquid. A sump is configured to receive cryogenic liquid from the bulk tank. A first positive-displacement pump is positioned within the sump and is configured to be submerged, and pump cryogenic liquid stored, within the sump. A second positive-displacement pump is also positioned within the sump and is configured to be submerged, and pump cryogenic liquid stored, within the sump. A vaporizing heat exchanger is configured to receive and vaporize cryogenic liquid pumped from the first pump and/or the second pump.

In another aspect, a method for dispensing a cryogenic fluid includes the steps of storing a cryogenic liquid in a bulk tank, directing cryogenic liquid from the bulk tank to a sump, submerging a first positive-displacement pump and a second positive-displacement pump in cryogenic liquid in the sump, pumping cryogenic liquid from the sump to a vaporizing heat exchanger using the first positive-displacement pump and/or the second positive displacement pump, vaporizing the cryogenic liquid in the vaporizing heat exchanger to form cryogenic vapor, and dispensing the cryogenic vapor.

### BRIEF DESCRIPTION OF THE DRAWINGS

FIG. 1 is a schematic of the jacketed bulk storage tank and sumps containing pumps in an embodiment of the cryogenic fluid dispensing system of the disclosure.

FIG. 2 is a schematic of a vaporizing subsystem in an embodiment of the cryogenic fluid dispensing system of the disclosure.

FIG. 3 is a schematic of a warming fluid subsystem in an embodiment of the cryogenic fluid dispensing system of the disclosure.

### DETAILED DESCRIPTION OF EMBODIMENTS

While the embodiments of the disclosure are presented below as hydrogen refueling stations for fuel cell vehicles, it is to be understood that the technology may be used to dispense alternative cryogenic fluids in alternative applications.

It should be noted herein that the lines, conduits, piping, passages and similar structures and the corresponding streams are sometimes both referred to by the same element number set out in the figures.

Reference numerals that are introduced in the specification in association with a drawing figure may be repeated in one or more subsequent figures for shared elements or components without additional description in the specification in order to provide context for other features.

In the claims, letters are used to identify claimed steps (e.g. a., b. and c.). These letters are used to aid in referring to the method steps and are not intended to indicate the order in which the claimed steps are performed, unless and only to the extent that such order is specifically recited in the claims.

In an embodiment of the cryogenic fluid dispensing system of the disclosure, a bulk tank and a pair of sumps 12a and 12b are positioned within a jacket 14. Air is at least partially evacuated from the interior of the jacket so as to provide vacuum insulation for the bulk tank 10 and the sumps 12a and 12b. The jacket 14 may be buried underground to preserve space above ground and provide insulation for the jacket.

The bulk tank 10 contains a supply of liquid hydrogen 16 and is refilled by a system of fill lines, indicated in general at 18, that include portions passing through the interior of the jacket 14. The tank may be filled from the liquid side via fill line 22 or via fill line 23 and a spray bar 24 positioned within the headspace of the tank based on the settings of valves 25 and 27. Liquid entering the bulk tank 14 via the spray bar 24 may collapse a pressure head to reduce the pressure in the tank. In addition, the bulk tank 10 is provided with a vent line 26 that leads to a vent stack via fittings 27. The bulk tank 14 is also provided with emergency vent lines 28 and 32 which are provided with emergency vent valves 34 and 36, respectively.

Liquid hydrogen 16 from the bulk tank 10 is transferred to sumps 12a and 12b via lines 38a and 38b when valves 42a and 42b are opened, respectively.

A liquid level sensor (not shown) is configured to determine the level of liquid hydrogen in each sump 12a and 12b so as to provide an indication when a sump needs to be refilled. As examples only, the liquid level sensor may include a differential pressure gauge of the type illustrated in commonly owned U.S. Pat. Nos. 6,542,848; 6,782,339 and/or 6,944,570 to Neeser et al., the contents of each of which are hereby incorporated by reference.

A first positive-displacement pump 44 and a second positive-displacement pump 46 are each positioned within the sump 12a and submerged within liquid hydrogen 48 that is supplied by the bulk tank 10, as will be described below. An inlet of the pump receives the liquid within the sump for pumping. Pumps 44 and 46 are kept cool between uses due to being submerged within the liquid hydrogen 48. As a result, the need for recirculation of liquid through the pumps for cooldown upon startup is minimized or eliminated.

Motors 52 and 54, which are positioned outside of the sump 12a, drive the pumps 44 and 48, respectively, via drive rods or shafts. As described in commonly assigned U.S. Patent Application Publication No. US 2021/0404604 to Drube et al., the contents of which are hereby incorporated by reference, subcooling of the liquid hydrogen 48 within sump 12a may be accomplished by heating the vapor within the sump headspace via heat transfer from the motor 52 to the headspace via the corresponding drive rod or shaft. Motors 52 and 54 are preferably hydraulic motors.

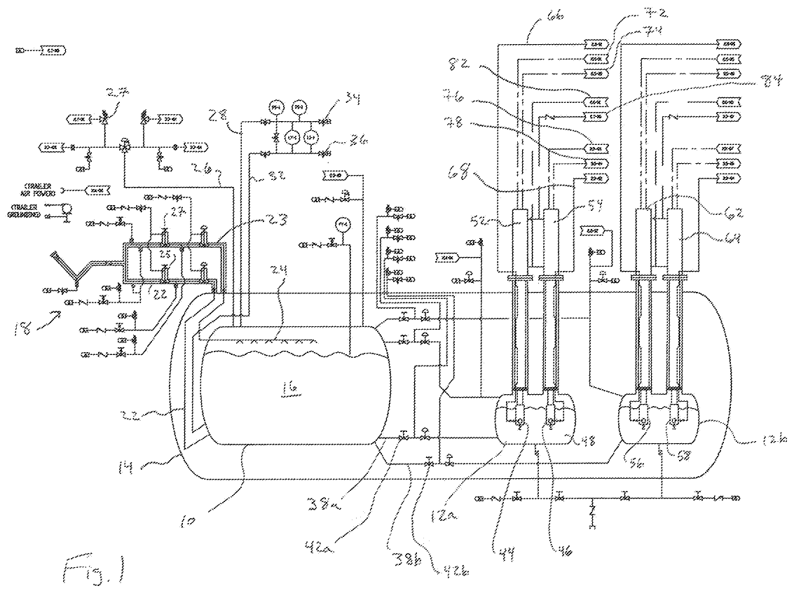

As illustrated in FIG. 1, sump 12b similarly contains two pumps 56 and 58, which are powered by motors 62 and 64. The structure and operation of sump 12b and pumps 56 and 58 are the same as sump 12a and pumps 44 and 46. The following discussion will therefore focus solely on sump 12a and pumps 44 and 46 to avoid duplication and applies to sump 12b and pumps 56 and 58 as well.

While two sumps are illustrated, with each sump including two pumps, the number of sumps may be varied and the number of pumps per sump may be more than two.

A liquid line 66 receives liquid hydrogen from the outlet of the pump 44 and directs it to the vaporizing subsystem as described below with reference to FIG. 3. Liquid line 68 similarly receives liquid hydrogen from the outlet of the pump 46 and directs it to the vaporizing subsystem.

The motor 52 receives hydraulic fluid via line 72 from a pressurized source, as is known in the art, so that the pump 44 is actuated. Warmed hydraulic fluid exits the motor 52 via line 74. The motor 54 similarly receives hydraulic fluid via line 76 from a pressurized source so that the pump 46 is actuated. Warmed hydraulic fluid exits the motor 54 via line 78.

An inert purging fluid, such as nitrogen vapor, is directed through the pumps 44 and 46 and sump 12a via purge fluid supply line 82 and purge fluid withdraw line 84 when the sump 12a is drained for maintenance or repair of the pumps. As examples only, the nitrogen vapor may be provided from a tank containing a pressurized supply of nitrogen vapor or a tank containing liquid nitrogen that is directed to a heat exchanger or other warming device prior to line 82.

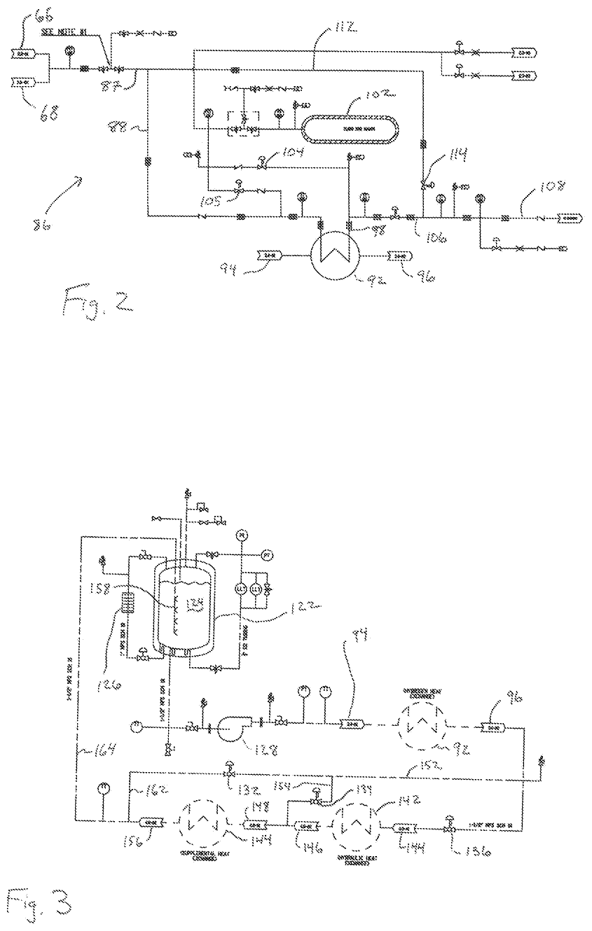

With reference to FIG. 2, pumped hydrogen traveling through lines 66 (from pump 44 of FIG. 1) and/or 68 (from pump 46 of FIG. 1) is received by line 87 of a vaporing subsystem indicated in general at 86. Hydrogen liquid flowing through line 87 may be directed through line 88 to vaporizing heat exchanger 92 where it is warmed and vaporized by a warming fluid stream entering the heat exchanger via line 94 and exiting the heat exchanger via line 96. The resulting hydrogen vapor stream exits the vaporizing heat exchanger 92 via line 98. The vaporizing heat exchanger 92 of FIG. 2 therefore vaporizes hydrogen liquid from pumps 44 and 46 of FIG. 1 individually (i.e. when only one of the pumps is operating) or jointly (i.e. when both of the pumps are operating). The hydrogen vapor stream flows through line 106 and out of the vaporizing subsystem through line 108 to a dispenser for delivery to the vehicle being refueled.

A portion of the hydrogen vapor stream in line 98 may be directed to a buffer tank 102 by opening valve 104 to provide pressurized hydrogen vapor storage in the tank 102. Valve 104 is closed when the pressure of the stored hydrogen vapor within tank 102 reaches the desired level. Pressurized hydrogen vapor from tank 102 may be used to supplement the flow of hydrogen through line 88 by opening valve 105 (with valve 104 remaining closed) if necessary. For example, valve 105 may be opened when the pumps 44 and 46 can't keep up with the demands of the dispensing system.

A portion of the hydrogen liquid flowing through line 87 may be directed through warming bypass line 112 when warming bypass valve 114 is opened or partially opened. Bypass line 112 joins line 106 so that the hydrogen liquid flowing in the bypass lines joins the hydrogen vapor traveling through line 106. As a result, the temperature of the hydrogen vapor dispensed through line 108 may be adjusted by manipulation of valve 114.

As noted above with reference to FIG. 2, liquid hydrogen flowing through heat exchanger 92 is warmed by a warming fluid stream entering the heat exchanger via line 94 and exiting the heat exchanger via line 96. A subsystem for providing warming fluid stream 94 to heat exchanger 92 is illustrated in FIG. 3. A warming fluid storage or supply tank 122, which is preferably jacketed to provide vacuum insulation, contains a supply of warming fluid 124, which may contain or include, as examples only, propylene glycol, or other hydrocarbon. The warming fluid storage tank may be provided with a pressure building circuit including heat exchanger 126, which vaporizes liquid from the bottom of the tank and directs the resulting vapor to the tank head space.

Liquid from the warming fluid storage tank may be pumped via pump 128 to the heat exchanger 92 as stream 94. As a result, the liquid hydrogen flowing through the heat exchanger 92 is vaporized and exits as vapor stream 98 (shown in FIG. 2). A resulting cooled warming fluid stream 96 exits the heat exchanger 92 and, depending on the settings of valves 132, 134 and 136, may be directed to hydraulic fluid heat exchanger 142 and/or supplemental heat exchanger 144 for warming and/or directed back to the bulk tank 122.

Hydraulic fluid heat exchanger 142 of FIG. 3 receives hydraulic fluid from the pump motors 52 and/or 54 of FIG. 1 via lines 74 and/or 78 of FIG. 1 after the hydraulic fluid is warmed due to use in articulating the corresponding pumps. With reference to FIG. 3, when valve 136 is at least partially opened, a cooled warming fluid stream 144 entering heat exchanger 142 is warmed by the hydraulic fluid from lines 74 and/or 78 (of FIG. 1) to provide warmed warming fluid stream 146.

If valves 134 and 136 of FIG. 3 are both at least partially open, a portion of stream 96 flows through lines 152 and 154, with another portion flowing to heat exchanger 142. As a result, streams 146 and 154 combine to form stream 148, which flows into supplemental heat exchanger 144. Alternatively, if valve 134 is closed, all of stream 146 flows into supplemental heat exchanger 144 as stream 148.

Supplemental heat exchanger 144 provides warming of stream 148 and, as examples only, may be a catalytic heat exchanger, a forced-air heat exchanger, an electric heat exchanger or an ambient heat exchanger. In addition, while one supplemental heat exchanger 144 is illustrated in FIG. 3, two or more supplemental heat exchangers may be used or the supplemental heat exchanger 144 may be eliminated. A further warmed warming fluid stream 156 exits supplemental heat exchanger 144 and is directed back to a spray bar 158 positioned within the warming fluid storage tank 122 so that the warming fluid 124 within the tank is warmed.

If bypass valve 132 is at least partially opened, a stream 162 will join stream 156 prior to a resulting stream 164 being directed back to the spray bar 158 within the warming fluid storage tank 122. As a result, the temperature of the warming fluid returning to the storage tank 122 may be controlled.

By providing two (or more) pumps in a sump, the embodiment described above provides a broader range of pumping rates. More specifically, a single pump within the sump may be operated or both pumps may be operated. Furthermore, the pumping rate(s) and/or hydraulic coordination of the two pumps may be adjusted up to and including having one of the pumps idle. In addition, use of both pumps enables quicker subcooling of the liquid hydrogen in the sump, when both pumps are operating, due to the sump receiving heat from both of the two pump motors.

Furthermore, the embodiment described above offers efficiency in that it uses heat energy from warmed hydraulic fluid returned from the pump motor(s) to recondition the warming fluid after it is used to vaporize the pumped hydrogen liquid.

While the preferred embodiments of the invention have been shown and described, it will be apparent to those skilled in the art that changes and modifications may be made therein without departing from the spirit of the invention.

What is claimed is:

1. A system for dispensing a cryogenic fluid comprising:
a. a bulk tank configured to contain a supply of a cryogenic liquid;
b. a sump configured to receive cryogenic liquid from the bulk tank;
c. a first positive-displacement pump positioned within the sump and configured to be submerged within and pump cryogenic liquid stored within the sump;
d. a second positive-displacement pump positioned within the sump and configured to be submerged within and pump cryogenic liquid stored within the sump;
e. a vaporizing heat exchanger configured to receive and vaporize cryogenic liquid pumped from the first pump and/or the second pump.

2. The system of claim 1 wherein the bulk tank and the sump are positioned within a jacket wherein the interior of the jacket is at least partially evacuated of air.

3. The system of claim 1 wherein the cryogenic liquid is liquid hydrogen.

4. The system of claim 1 wherein the vaporizing heat exchanger receives a warming fluid so that the cryogenic liquid is warmed and vaporized by the warming fluid in the vaporizing heat exchanger.

5. The system of claim 4 wherein the first positive-displacement pump and the second positive-displacement pump are powered jointly or independently by at least one hydraulic motor and further comprising a hydraulic fluid heat exchanger configured to receive cooled warming fluid from the vaporizing heat exchanger wherein the hydraulic fluid heat exchanger is further configured to receive warmed hydraulic fluid from the at least one hydraulic motor so that the cooled warming fluid from the vaporizing heat exchanger is warmed in the hydraulic fluid heat exchanger.

6. The system of claim 5 further comprising a warming fluid storage tank in fluid communication with the hydraulic fluid heat exchanger so as to receive and store warming fluid, said warming fluid storage tank configured to provide warming fluid to the vaporizing heat exchanger.

7. The system of claim 6 further comprising a supplemental heat exchanger configured to receive and warm warming fluid from the hydraulic fluid heat exchanger and direct warming fluid to the warming fluid supply tank.

8. A method for dispensing a cryogenic fluid comprising the steps of:
a. storing a cryogenic liquid in a bulk tank;
b. directing cryogenic liquid from the bulk tank to a sump;
c. submerging a first positive-displacement pump and a second positive-displacement pump in cryogenic liquid in the sump;
d. pumping cryogenic liquid from the sump to a vaporizing heat exchanger using the first positive-displacement pump and/or the second positive displacement pump;
e. vaporizing the cryogenic liquid in the vaporizing heat exchanger to form a cryogenic vapor;
f. dispensing the cryogenic vapor.

9. The method of claim 8 wherein the cryogenic liquid is liquid hydrogen.

10. The method of claim 8 wherein step e. is performed using a warming fluid that warms and vaporizes the cryogenic liquid in the vaporizing heat exchanger whereby the warming fluid is cooled.

11. The method of claim 10 wherein the first positive-displacement pump is powered by a first hydraulic motor and the second positive displacement pump is powered by a second hydraulic motor during step d. and further comprising the step of warming the cooled warming fluid in a hydraulic fluid heat exchanger using warm hydraulic fluid from the first hydraulic motor and/or the second hydraulic motor.

12. The method of claim 11 further comprising the step of receiving and storing warming fluid from the hydraulic fluid heat exchanger in a warming fluid storage tank.

13. The method of claim 12 further comprising the step of warming the warming fluid using a supplemental heat exchanger.

14. The method of claim 8 further comprising the step of insulating the bulk tank and the sump using a jacket containing the bulk tank and the sump where the interior of the jacket is at least partially evacuated of air.
